(19) United States
(12) Patent Application Publication
(10) Pub. No.: US 2025/0058485 A1
(43) Pub. Date: Feb. 20, 2025

(54) Hair Cutter with Improved Energy Storage

(71) Applicant: Andis Company, Sturtevant, WI (US)

(72) Inventors: Andrew Zendek, Cudahy, WI (US); Aleksandar Djuric, Milwaukee, WI (US); Richard J. Tringali, Racine, WI (US); Paul Shackett, Oak Creek, WI (US); Collin DeOcampo, Milwaukee, WI (US)

(21) Appl. No.: 18/450,920

(22) Filed: Aug. 16, 2023

(51) Int. Cl. B26B 19/38; B26B 19/06; H02K 33/16

(52) U.S. Cl. CPC B26B 19/3873; B26B 19/06; H02K 33/16; B26B 19/282

(57) ABSTRACT

A hair cutter with an energy storage device is provided. The energy storage device is connected to the motor through a circuit that powers the motor to oscillate a translating blade over a stationary blade. When the hair cutter is operating the energy storage device is discharged. When the energy storage device is completely discharged, the hair cutter is recharged, for example, by connecting the hair cutter to a power outlet. The electrical circuit connects the energy storage device to a voltage and/or current input to charge the energy storage device. In various specific embodiments, the energy storage device is a hybrid capacitor that includes characteristics of a supercapacitor and a lithium-ion battery.

### BACKGROUND OF THE INVENTION

The present invention generally relates to the field of hair cutters. Haircutters include a blade set that has a fixed blade in face-to-face relation with a movable blade. An electric motor drives the movable blade relative to the fixed blade to create a reciprocating motion to move overlapping cutting teeth on the respective blades relative to each other. Shearing action cuts hair located within the teeth when the blades translate. The present disclosure relates specifically to energy storage assemblies used to power the motor during operation.

### SUMMARY OF THE INVENTION

One embodiment of the invention relates to a hair cutter. The hair cutter includes a handle, a stationary blade, a translating blade, an electric motor, a capacitor, and a circuit. The handle has an enclosure defining an interior. The stationary blade is fixed to the enclosure and includes a first set of cutting teeth. The translating blade includes a second set of cutting teeth slidably supported relative to the stationary blade such that the first and second sets of cutting teeth cooperate to cut hair when the translating blade slides relative to the stationary blade. The interior of the handle supports the electric motor. The electric motor has first and second contacts for applying electrical energy to the motor. The motor is fixed to the enclosure and coupled to the translating blade to slide the translating blade relative to the stationary blade when electrical energy is applied to the electric motor. The capacitor has a capacitance of at least 150 Farads and a volume less than 1 cubic inch. The capacitor includes a first electrode, a second electrode, the first and second electrodes are separated by an ion-permeable membrane and an electrolyte. The electrolyte connects the first and second electrodes. The circuit connects the first and second contacts of the electric motor to the first and second electrodes of the capacitor to selectively apply electrical energy to the electric motor. An energy storage capacity of the capacitor is less than 0.3 watt hours.

Another embodiment of the invention relates to a hair cutter. The hair cutter includes a handle, a stationary blade, a translating blade, an electric motor, an energy storage device, and a circuit. The handle has an enclosure defining an interior. The stationary blade is fixed to the enclosure and includes a first set of cutting teeth. The translating blade includes a second set of cutting teeth slidably supported relative to the stationary blade such that the first and second sets of cutting teeth cooperate to cut hair when the translating blade slides relative to the stationary blade. The interior of the handle supports the electric motor. The electric motor has first and second contacts for applying electrical energy to the motor. The motor is fixed to the enclosure and coupled to the translating blade to slide the translating blade relative to the stationary blade when electrical energy is applied to the electric motor. The energy storage device is supported within the interior of the handle and includes a first capacitor and a second capacitor, the second capacitor is connected to the first capacitor in parallel. The first capacitor includes a first electrode and a second electrode. The first and second electrodes are separated by an ion-permeable membrane and an electrolyte connects the first and second electrodes. The second capacitor includes a third electrode and a fourth electrode. The third and fourth electrodes are separated by an ion-permeable membrane and an electrolyte connects the third and fourth electrodes. The circuit connects the first and second contacts to the energy storage device to selectively apply electrical energy to the electric motor.

Another embodiment of the invention relates to a cordless hair cutter powered by rechargeable energy storage device. The hair cutter includes a handle, a stationary blade, a translating blade, an electric motor, an energy storage device, and a circuit. The handle has an enclosure defining an interior. The stationary blade is fixed to the enclosure and includes a first set of cutting teeth. The translating blade includes a second set of cutting teeth slidably supported relative to the stationary blade such that the first and second sets of cutting teeth cooperate to cut hair when the translating blade slides relative to the stationary blade. The interior of the handle supports the electric motor. The electric motor has first and second contacts for applying electrical energy to the motor. The motor is fixed to the enclosure and coupled to the translating blade to slide the translating blade relative to the stationary blade when electrical energy is applied to the electric motor. The energy storage device is supported within the interior of the handle. The circuit connects the first and second contacts to the energy storage device to selectively apply electrical energy to the electric motor. The energy storage device has a ratio of charge time to run time of about 1 to 5.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a hair cutter, according to an exemplary embodiment.

FIG. 2 is a view of the bottom or operating end of hair cutter of FIG. 1.

FIG. 3 is a perspective view of the haircutter of FIG. 1 with the cover or upper housing removed, according to an exemplary embodiment.

FIG. 4 is a perspective view of the haircutter of FIG. 1, with both the upper housing and motor cover removed, according to an exemplary embodiment.

FIG. 5 is a perspective view of a haircutter, with both the upper housing and motor cover removed, according to another exemplary embodiment.

FIG. 6 is a perspective view of the operable connection of a motor, a drive assembly, and a blade assembly, according to an exemplary embodiment.

FIG. 7 is a side view of the operable connection between the motor, the drive assembly, and the blade assembly, taken from the perspective of 7-7 in FIG. 6.

FIG. 8 is a top view of the operable connection between the motor, the drive assembly, and the blade assembly.

FIG. 9 is a perspective view of the motor, the drive assembly, and the blade assembly of FIG. 6, the drive assembly is shown in a partially exploded view.

FIG. 10 is a cross-sectional view of the motor, the drive assembly, and the blade assembly of FIGS. 6-9, taken along line 10-10 of FIG. 8.

FIG. 11 is an exploded view of the blade assembly of FIG. 6.

FIGS. 12A-D are block diagrams showing a charge path and discharge path for an energy storage device, according to various exemplary embodiments.

### DETAILED DESCRIPTION

Referring generally to the figures, various embodiments of a cordless hair cutter 10 are shown. A motor 54 powers a translating blade 28 that oscillates or translates over a stationary blade 26. An energy storage device, which for various embodiments is a supercapacitor and/or a hybrid capacitor, is used to store energy that can later be used to power the motor. The term “hair cutter” is inclusive, and refers to any hair grooming device, including, but not limited to, a hair trimmer, a hair clipper, or any other hair cutting or hair grooming device. In addition, the hair grooming device can be suitable for a human, animal, or any other suitable living or inanimate object having hair.

Applicant believes the hybrid capacitor discussed herein includes a volume able to fit within a cordless hair cutter and also able to provide a sufficient amount of energy to operate a cordless hair cutter for a useful amount of time. In contrast to use of capacitors used for energy storage in other devices (i.e., other types of personal care devices) that only store enough energy for a few applications or minutes of use, Applicant believes the various hybrid capacitors discussed herein provide improved run time (time hair cutter is powered and/or operable) and charge time to run time ratio while maintaining a volume for the capacitor suitable for a cordless hair cutter.

Further, the energy storage devices discussed herein have the additional advantage of having an energy storage capacity of less than 0.3 watt hours. Various other energy storage devices such as Lithium-ion batteries are subject to restrictions such as shipping restrictions (United Nations 38.3) due to the potential danger of transporting the energy storage devices or the commercial products that include the energy storage devices. As will be discussed in greater detail below, the use of the hybrid capacitor provides some of the energy related benefits of lithium-ion batteries. However, by using hybrid capacitors with energy storage capacity of less than 0.3 watt hours, the extra costs and limitations imposed by shipping hazardous energy storage devices and commercial products like hair cutters that include the energy storage devices can be avoided.

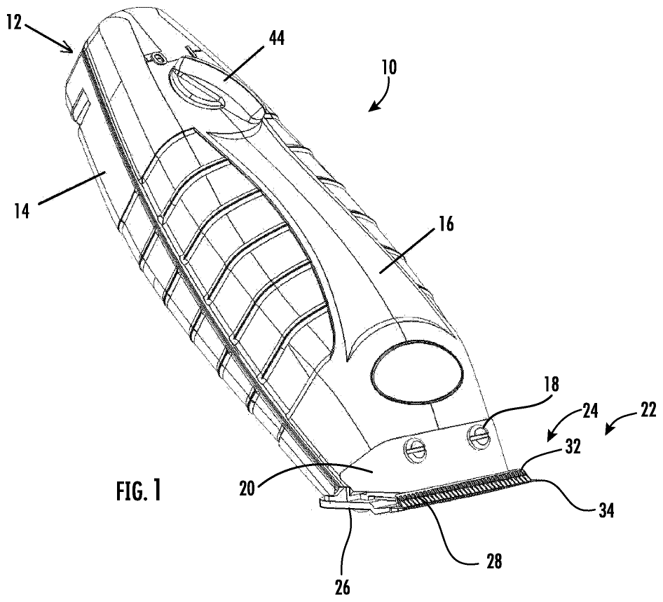

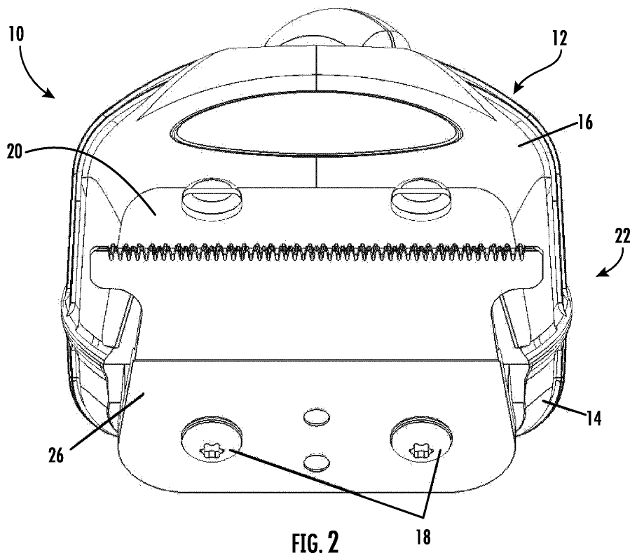

Referring to the figures, FIG. 1 illustrates an embodiment of a hair cutter 10 having a handheld housing, handle, or body 12. Body 12 is defined by a first or lower housing 14 and a removable cover or upper housing 16. Lower housing 14 and upper housing 16 are coupled by a plurality of fasteners 18 (e.g., bolts, screws, etc.). Fasteners 18 also couple other components of hair cutter 10. Fasteners 18 may couple a shield 20 to the blade assembly 22. For example, the lower housing 14 and upper housing 16 are configured to snap together to reduce or eliminate the need for fasteners 18. A blade assembly 22 is coupled to a first or cutting end 24 of the body 12. The blade assembly 22 includes a lower outer blade or stationary blade 26 and an upper or inner blade or translating blade 28. The translating blade 28 is supported on a surface of the stationary blade 26 and is movable with respect to the stationary blade 26. The translating blade 28 can include a drive socket configured to engage a reciprocating or oscillating drive assembly 30 (shown in FIG. 2). Translating blade 28 couples to other structures that engage the reciprocating or oscillating drive assembly 30. Drive assembly 30 is configured to generate oscillating or reciprocating movement of blade assembly 22 to facilitate cutting hair.

Blade assembly 22 is coupled to cutting end 24 of hair cutter 10. Translating blade 28 includes translating cutting teeth 32 (e.g., a first set, inner, or upper cutting teeth). Stationary blade 26 includes stationary cutting teeth 34 (e.g., a second set, outer, or lower cutting teeth). As translating blade 28 oscillates over stationary blade 26, translating cutting teeth 32 cooperate with stationary cutting teeth 34 to cut hair.

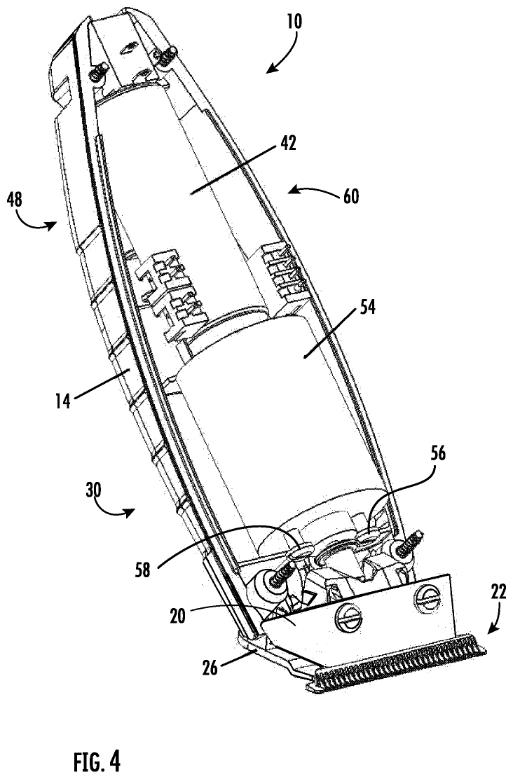

FIG. 2 shows an end view of hair cutter 10. From this perspective, the operating end or blade assembly 22 including a blade assembly 22 is shown from an end view of stationary blade 26. Fasteners 18 couple stationary blade 26 to body 12 (e.g., lower housing 14 and/or upper housing 16). Shield 20 covers a top of blade assembly 22 to prevent hair and/or other debris from entering the drive assembly 30 (FIGS. 4-14).

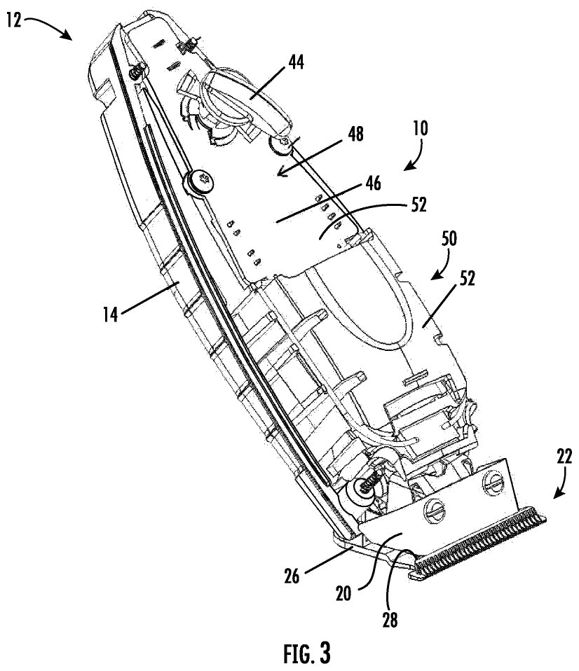

FIG. 3 shows a perspective view of hair cutter 10 with a cover or upper housing 16 removed. In this configuration, body 12 is incomplete and includes only lower housing 14. Switch 44 is shown at a location above where upper housing 16 would be situated. Switch 44 controls energy hybrid capacitor 42 (FIG. 4) to power circuit 46 and drive a power assembly 48. Power assembly 48 supplies power from hybrid capacitor 42 to motor assembly 50. Motor assembly 50 is coupled to blade assembly 22. Motor assembly 50 is captured between lower housing 14 and motor cover 52. Shield 20 and stationary blade 26 cooperate to prevent hair or other debris from entering blade assembly 22 and preventing the translating motion of translating blade 28.

FIG. 4 shows a perspective view of hair cutter 10 with both upper housing 16 and motor cover 52 removed. Hair cutter 10 includes drive assembly 30 and power assembly 48. As illustrated, power assembly 48 electrically connects to the hybrid capacitor 42 to an electric motor 54 in drive assembly 30. In the illustrated embodiment, the lower housing 14 contains drive assembly 30 with electric motor 54. Electric motor 54 may be disposed anywhere within body 12.

As shown in FIG. 4, electric motor 54 is a brushless magnetic motor 54. As is generally understood, brushed motors include brushes to mechanically commutate the motor while brushless motors instead use electronic controls. However, in other embodiments, electric motor 54 can be a pivot motor 54, a linear motor 54, a rotary motor 54, or any other suitable motor 54 for generating oscillating or reciprocating movement of blade assembly 22. In various embodiments, electric motor 54 may be a rotating brushless DC motor 54 or a linear brushless DC motor 54, or another direct current electric motor 54 or rotating electric motor 54. In various embodiments, electric motor 54 is a brushed DC motor.

Electric motor 54 has a first contact 56 (e.g., positive contact) and a second contact 58 (e.g., negative contact). The first contact 56 and second contact 58 receive electrical energy from hybrid capacitor 42 and apply it to electric motor 54. In one embodiment, electric motor 54 is a direct current motor 54, and motor assembly 50 includes a winding, magnets, a commutator, and brushes. In various embodiments, the winding has first and second terminals (e.g., coupled to first contact 56 and second contact 58) and a permanent magnet. The permanent magnets and the terminals are coupled to first and second brushes at the respective terminals of the winding. The first brush being coupled to the first contact 56 and the second brush being coupled to the second contact 58. For example, the electric motor 54 is a linear, translating motor 54 having a winding and an armature with one of the winding and the armature being fixed to the enclosure and the other of the winding and the armature being coupled to the translating blade 28. Motor 54 oscillates translating blade 28 over stationary blade 26.

For example, electric motor 54 is supported within a volume or interior 60 of the handle or body 12. Electric motor 54 has first contact 56 and second contact 58 to receive electrical energy from hybrid capacitor 42. Motor 54 revolves an output or drive shaft 62 coupled to drive assembly 30. Motor 54 is fixed within interior 60 of the enclosure and coupled to translating blade 28 to slide translating blade 28 relative to stationary blade 26 when electrical energy is applied to electric motor 54.

As shown, hybrid capacitor 42 is positioned within body 12. A switch 44 is positioned on an external part of body 12 (as illustrated in FIG. 1 switch 44 is on upper housing 16, but may be disposed on lower housing 14 or a joint between lower housing 14 and upper housing 16). Switch 44 completes a circuit to power drive assembly 30 (FIG. 4-9) “on” or “off.” Switch 44 is user operable; for example, it can be actuated by fingers and/or a thumb of the user. Positioning switch 44 into the “on” position provides electrical power from hybrid capacitor 42 to drive assembly 30. Positioning switch 44 into the “off” position terminates the electrical power from hybrid capacitor 42 to drive assembly 30.

As is generally understood, hybrid capacitors or Lithium-ion capacitors incorporate characteristics of both supercapacitors and lithium-ion batteries. In other words, one portion or electrode of the hybrid capacitor (i.e., the cathode, first electrode) uses an electric double-layer mechanism to store energy, while the other electrode (i.e., the anode, second electrode) uses lithium ions. The first and second electrodes are separated or divided by a separator such as an ion-permeable membrane. An electrolyte ionically connects both the first and second electrodes.

When the electrodes are polarized by an applied voltage, ions in the electrolyte form electric double layers of opposite polarity to the electrode's polarity, for example, positively polarized electrodes will have a layer of negative ions at the electrode/electrolyte interface along with a charge-balancing layer of positive ions adsorbing onto the negative layer. The opposite is true for a negatively polarized electrode. The anode is generally formed from a carbon-based material able to absorb ions, such as lithium ions meaning the anode charges and discharges through an oxidation-reduction (redox) reaction of the ions.

The circuit 46 connects the first and second contacts of the electric motor 54 to the first and second electrodes of the hybrid capacitor 42 to selectively apply electrical energy from the hybrid capacitor 42 to the electric motor 54. In various embodiments more than a single hybrid capacitor 42 are used to power hair cutter 10. In a specific embodiment, a first hybrid capacitor 42 is connected to a second hybrid capacitor 42 in parallel. In other words, a first electrode of the first hybrid capacitor 42 is connected to a first electrode of the second hybrid capacitor while a second electrode of the first hybrid capacitor is connected to the second electrode of the second hybrid capacitor. In such an embodiment, the first electrode of the first capacitor is connected to the charging path or voltage input and the second electrode of the first capacitor is connected to the discharge path and/or motor 54. In various embodiments, the first hybrid capacitor 42 is connected to the second hybrid capacitor 42 in series.

Applicant has found that hybrid capacitors 42 have a high energy density storage (higher than a supercapacitor) and a greater power density than lithium-ion batteries. Hybrid capacitor 42 includes a volume able to fit within a cordless hair cutter 10 and also able to provide a sufficient amount of energy to operate a cordless hair cutter 10 for a useful amount of time. The hybrid capacitor 42 is rechargeable between hair cutting operations.

In a specific embodiment, hair cutter 10 includes a single hybrid capacitor 42 (see FIG. 4). In various specific embodiments, hybrid capacitor 42 has a capacitance of at least 150 Farads and more specifically at least 200 Farads. In a specific embodiment, hybrid capacitor 42 has a capacitance of about 220 Farads (i.e., 220 Farads plus or minus 10 Farads).

In various embodiments, hybrid capacitor 42 has a volume of less than 2 cubic inches, specifically less than 1.5 cubic inches, and more specifically less than 1 cubic inch. For example, in various embodiments hybrid capacitor 42 has a volume less than 0.5 cubic inches. In such an embodiment, hybrid capacitor 42 has a volume of about 0.31 cubic inches (i.e., 0.31 cubic inches plus or minus 0.06 cubic inches). In a specific embodiment, hybrid capacitor 42 has a capacitance of at least 150 Farads and a volume of less than 1 cubic inch. In a specific embodiment, hybrid capacitor 42 is cylindrical.

In various embodiments, the capacity of power or watt hours of the hybrid capacitor 42 is less than 0.3 watt hours. In a specific embodiment the capacity of power of the hybrid capacitor 42 is less than 0.25 watt hours. In such an embodiment, the capacity of power is about 0.23 watt hours.

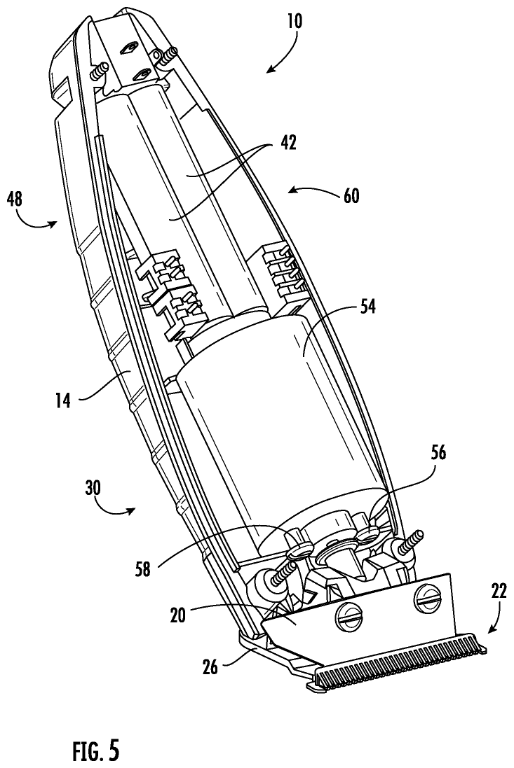

FIG. 5 shows a perspective view of hair cutter 10 with both upper housing 16 and motor cover 52 removed according to another exemplary embodiment. In such an embodiment, power assembly 48 electrically connects the electrochemical capacitor, supercapacitor, or hybrid capacitor 42 to an electric motor 54 in drive assembly 30. In the illustrated embodiment, the lower housing 14 contains drive assembly 30 with electric motor 54.

In the illustrated embodiment, hair cutter 10 includes two hybrid capacitors 42. In such an embodiment, a first hybrid capacitor 42 is connected to a second hybrid capacitor in parallel. Each hybrid capacitor 42 is rechargeable and has a capacitance of at least 150 Farads. In various embodiments, the first and second hybrid capacitors have a total equivalent capacitance of at least 300 Farads, specifically at least 350 Farads, and more specifically at least 400 Farads. In a specific embodiment, the first and second hybrid capacitors 42 have a total capacitance of about 440 Farads (i.e., 440 Farads plus or minus 10 Farads).

In various embodiments, hybrid capacitors 42 have a total volume of less than 2 cubic inches, specifically less than 1.5 cubic inches, and more specifically less than 1 cubic inch. For example, in various embodiments each hybrid capacitor 42 has a volume less than 0.5 cubic inches. In such an embodiment, each hybrid capacitor 42 has a volume of about 0.31 cubic inches (i.e., 0.31 cubic inches plus or minus 0.06 cubic inches) such that the total volume of hybrid capacitors 42 is about 0.61 cubic inches (i.e., 0.61 cubic inches plus or minus. 1 cubic inches). In a specific embodiment, hybrid capacitors 42 have a total capacitance of at least 400 Farads and a volume of less than 0.75 cubic inches. In a specific embodiment, each hybrid capacitor 42 is cylindrical.

In various embodiments, the total capacity of power or watt hours of the hybrid capacitors 42 is less than 0.6 watt hours. In a specific embodiment the total capacity of power of the hybrid capacitors 42 is less than 0.5 watt hours. In such an embodiment, the total capacity of power is about 0.46 watt hours.

As discussed above, the hybrid capacitors 42 have the energy density storage, power density and volume to make them suitable for operation of hair cutter 10 for a useful amount of time.

Hybrid capacitor 42 includes a volume able to fit within a cordless hair cutter 10 and also able to provide a sufficient amount of energy to operate a cordless hair cutter 10 for a useful amount of time. In contrast to use of capacitors used for energy storage in other devices (i.e., personal care devices) that only store enough energy for a few applications or minutes of use, Applicant believes the hybrid capacitor discussed herein provides improved run time (time hair cutter is powered and/or operable) and charge time to run time ratio while maintaining a volume for the capacitor suitable for a cordless hair cutter.

In various embodiments, hair cutter 10 includes a ratio of charge time to run time of about 1 to 5. In other words, for 3 minutes of charging, hair cutter 10 has a run time of about 15 minutes (i.e., 15 minutes plus or minus 2 minutes). In various specific embodiments, the ratio of charge time to run time can be adjusted (i.e., increase charge current, efficiency of motor voltage regulation, etc.). In various embodiments, hybrid capacitor 42 provides energy to hair cutter 10 such that hair cutter 10 has a run tome of at least five minutes and more specifically at least 10 minutes.

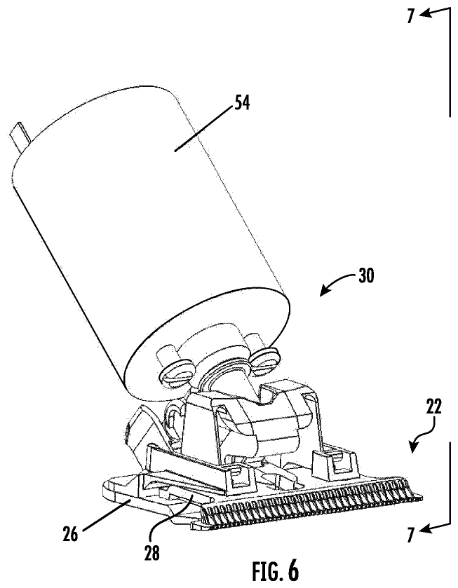

FIG. 6 is a perspective view of the operable connection of motor 54, drive assembly 30, and blade assembly 22. Hair cutter 10 is depicted with body 12 (e.g., both lower housing 14 and upper housing 16) removed to illustrate how drive assembly 30 interconnects motor 54 to blade assembly 22. Drive assembly 30 interconnects motor 54 to blade assembly 22. Blade assembly 22 includes a translating blade 28 and a stationary blade 26.

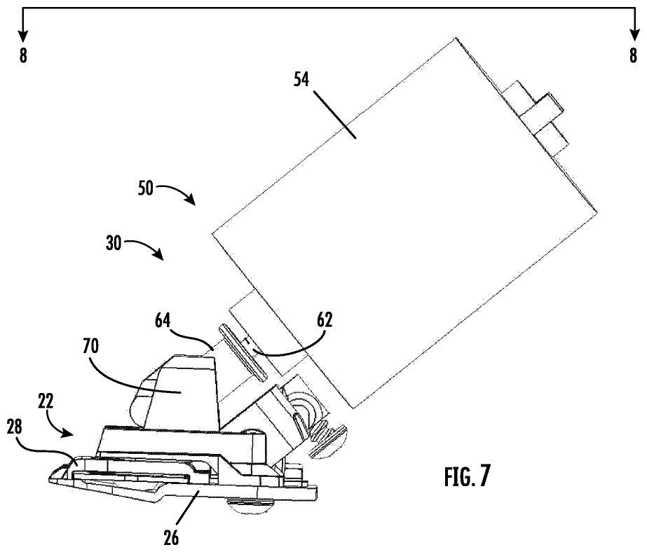

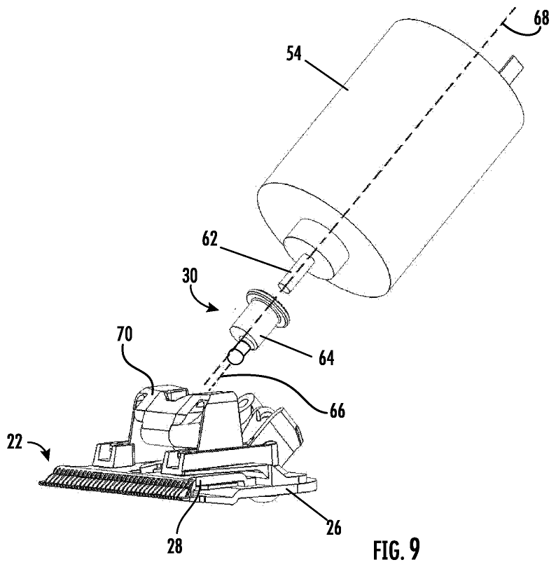

FIG. 7 is a side view of the operable connection between motor 54, drive assembly 30, and blade assembly 22, taken from the perspective of arrow 7-7 in FIG. 6. Motor assembly 50 includes the components for electric motor 54 to rotate an output or drive shaft 62. Drive assembly 30 couples drive shaft 62 to an eccentric drive 64. A longitudinal axis 66 of eccentric drive 64 is offset from the longitudinal axis 68 of drive shaft 62 and motor 54 (FIG. 9). In this way, eccentric drive 64 rotates at a distance about drive shaft 62. Eccentric drive 64 couples the drive shaft 62 to a yoke 70 that couples to eccentric drive 64 and oscillates as eccentric drive 64 rotates about drive shaft 62. Yoke 70 couples drive assembly 30 to blade assembly 22. For example, yoke 70 is rigidly or fixedly coupled to translating blade 28. Thus, as yoke 70 oscillates, translating blade 28 oscillates over stationary blade 26. In this way, translating blade 28 and stationary blade 26 cooperate to cut hair.

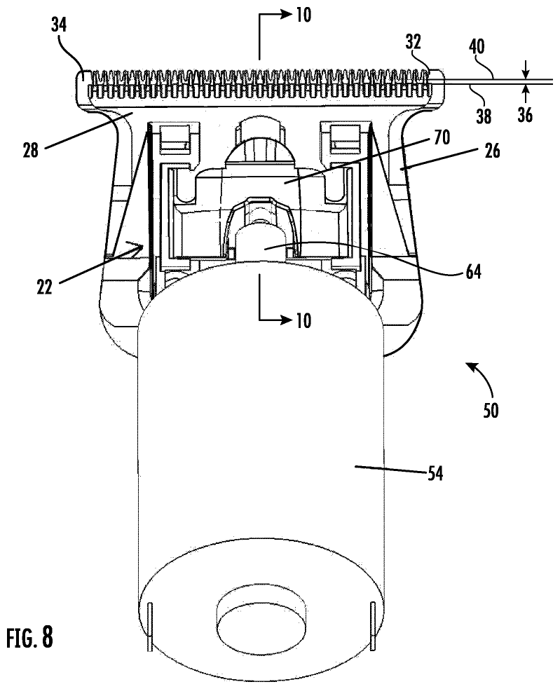

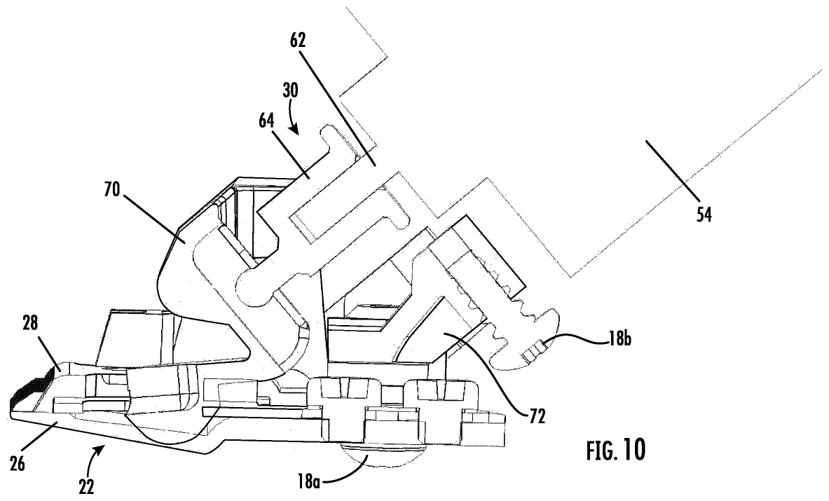

FIG. 8 is a top view of the operable connection between motor assembly 50, drive assembly 30, and blade assembly 22. The position of stationary blade 26 and/or translating blade 28 forms a gap 36. With reference to FIGS. 7 and 10 a view of the gap 36 formed between a translating edge 38 of translating cutting teeth 32 and a stationary edge 40 of stationary cutting teeth 34. Translating edge 38 (FIGS. 7 and 10) is formed at a root or base of the translating cutting teeth 32.

Similarly, stationary edge 40 (FIGS. 7 and 10) is formed at a root or base of the stationary cutting teeth 34. Gap 36 is the distance between translating edge 38 and stationary edge 40. The length of the cut can be controlled with a lever (not shown), or other mechanical system connected to the translating blade 28 and configured to control gap 36.

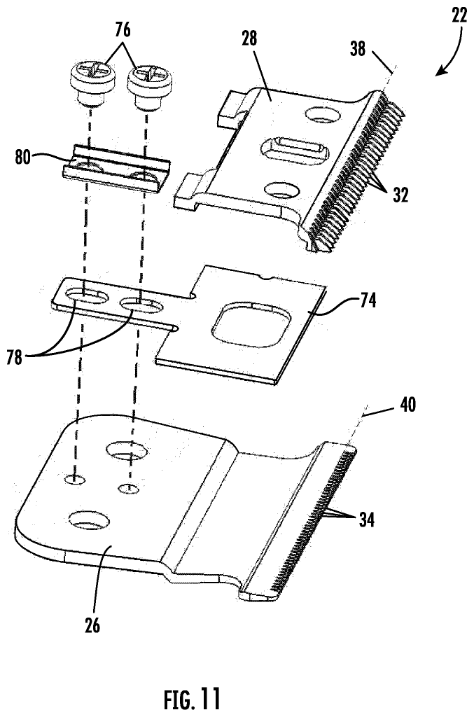

As gap 36 reduces, a shorter cut is achieved since the translating edge 38, and stationary edge 40 are near or adjacent to one another (e.g., in close proximity). FIG. 1 illustrates blade assembly 22 with a reduced gap 36, configured to make a shorter cut and to form a relatively small gap 36 (e.g., with the stationary blade 26 and translating blade 28 aligned or in close proximity). A larger gap 36 results in a longer cut. As translating blade 28 is repositioned away from stationary blade 26, stationary edge 40 (FIG. 11) and translating edge 38 (FIG. 11) are separated or offset by a greater distance (expanded or not in close proximity), resulting in a larger gap 36 and a longer cut.

As shown, motor 54 couples to drive shaft 62 (FIG. 7) within an eccentric drive 64. As eccentric drive 64 rotates about drive shaft 62, it causes yoke 70 to translate back and forth. Yoke 70 is coupled to translating blade 28, such that as yoke 70 oscillates translating blade 28 oscillates over stationary blade 26. This configuration causes translating cutting teeth 32 to oscillate or translate relative to stationary cutting teeth 34 and cooperate to cut hair.

FIG. 9 is a perspective view of motor 54, drive assembly 30, and blade assembly 22. In this view, drive assembly 30 is partially exploded to show the components that interconnect motor 54 to blade assembly 22. Drive assembly 30 includes drive shaft 62 coupled to motor 54, eccentric drive 64, and yoke 70. As shown, a longitudinal axis 66 of eccentric drive 64 is offset from the longitudinal axis 68 of motor 54 and drive shaft 62. This offset creates a distance between eccentric drive 64 and causes eccentric drive 64 to rotate about longitudinal axis 68 circularly (e.g., in a circular fashion that creates an eccentricity). The eccentric circular rotation about longitudinal axis 68 oscillates a receiver of yoke 70 and translating blade 28 over stationary blade 26.

FIG. 10 is a cross-sectional view of motor 54, drive assembly 30, and blade assembly 22, of FIGS. 5-8 taken along line 10-10 of FIG. 8. This view illustrates drive assembly 30, specifically how drive shaft 62 rotates eccentric drive 64 to create an eccentricity that rotates yoke 70. Yoke 70 is coupled to translating blade 28 which translates in response to the eccentric rotation of eccentric drive 64. FIG. 10 illustrates how fasteners 18 fix stationary blade 26 and lower housing 14 to body 12. For example, fasteners 18a couple stationary blade 26 to a blade frame 72 and fastener 18b couples lower housing 14 to blade frame 72, such that stationary blade 26 is fixedly coupled to body 12 of hair cutter 10.

FIG. 11 shows an exploded view of a blade set or blade assembly 22. Blade assembly 22 is located proximate to cutting end 24 of body 12 (FIG. 1). Blade assembly 22 is coupled to body 12 and captured between lower housing 14 and/or upper housing 16 to support the components of blade assembly 22 and interconnect blade assembly 22 to hair cutter 10.

Blade assembly 22 includes an outer, fixed, or stationary blade 26 and an upper, inner, or translating blade 28, and a T-guide 74. Translating blade 28 oscillates over and relative to stationary blade 26. For example, stationary blade 26 is fixed to blade frame 72 that is fixed to body 12 through an interior 60 of hair cutter 10. Stationary blade 26 includes stationary cutting teeth 34 that define stationary edge 40. Stationary blade 26 is coupled to blade assembly 22 (e.g., by screws or fasteners). Any suitable fastener 18 can secure stationary blade 26 to blade assembly 22. Stationary blade 26 includes a set of stationary cutting teeth 34 fixedly supported to body 12. Translating blade 28 includes a set of translating cutting teeth 32 and is slidably supported relative to stationary blade 26. Oscillation of translating blade 28 moves translating cutting teeth 32 relative to stationary cutting teeth 34 to cut hair.

Translating blade 28 is coupled to yoke 70 (e.g., by screws, rivets, or a peg on yoke 70 friction fit into holes on translating blade 28). Translating blade 28 and yoke 70, are biased toward stationary blade 26 by a biasing blade frame 72. Fasteners 18 couple blade frame 72 to stationary blade 26. Yoke 70 receives an eccentric drive 64 coupled to motor 54. The eccentric drive 64 inserts into yoke 70 and causes an oscillating motion from the output of the motor 54. Translating blade 28 and yoke 70 are supported, such that translating blade 28 moves back and forth across stationary blade 26 in response to movement of yoke 70 coupled to eccentric drive 64. Yoke 70 is coupled or attached to translating blade 28. Electric motor 54 includes a rotatable shaft that offsets the rotational output of motor 54 to oscillate translating blade 28 via its interaction with yoke 70.

T-guide 74 positions translating blade 28 relative to stationary blade 26, such that an internal ridge of translating blade 28 slides over the outermost edge (e.g., nearest translating cutting teeth 32). T-guide 74 can move translating blade 28 in a direction perpendicular to the oscillating motion, over stationary blade 26. In this way, T-guide 74 controls gap 36 to provide a longer or shorter cut length. As shown, screws 76 pass through receiving slots 78 of T-guide 74 to permit T-guide 74 to translate in a direction perpendicular to translating edge 38 and stationary edge 40. A bracket 80 may reduce friction between T-guide 74 and screws 76 as T-guide 74 translates to increase or decrease the length of the cut.

Blade frame 72 (FIG. 10) interconnects translating blade 28 to stationary blade 26. In this configuration, blade frame 72 receives a protrusion of translating blade 28 and fixedly couples or attaches stationary blade 26 to body 12. Blade frame 72 and T-guide 74 capture and guide translating blade 28 as it oscillates over stationary blade 26 fixedly coupled to body 12. This configuration stabilizes the forces (e.g., tensile forces) generated by the inner translating blade 28 and outer stationary blade 26. As a result, blade assembly 22 provides a more consistent load distribution and more evenly cuts hair. Stabilization reduces the lubrication between the component-parts of blade assembly 22. For example, the materials used to form blade frame 72 may be selected to reduce galling with translating blade 28 as it oscillates relative to stationary blade 26. Stabilization can reduce the energy output demands for motor 54 to oscillate translating blade 28 over stationary blade 26. This stabilization may reduce the size and/or dimensions of hybrid capacitor 42 and reduce energy demand.

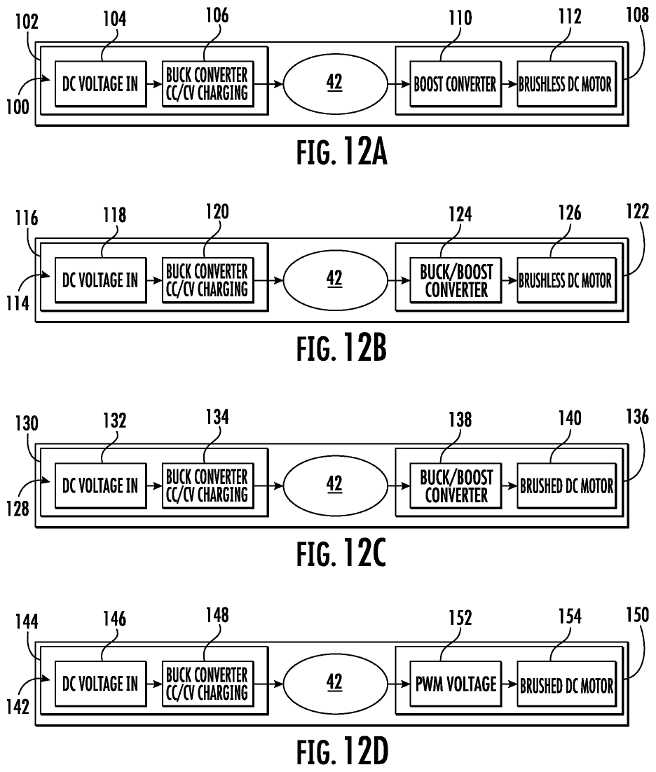

FIGS. 12A-D are block diagrams showing a charge path (see e.g., 102, 116, 130, 144) and discharge path (see e.g., 108, 122, 136, 150) for the power assembly 48 connected to hybrid capacitor 42, according to various exemplary embodiments. In general, the charge path (see e.g., 102, 116, 130, 144) will include a supplied DC voltage (see e.g., 104, 118, 132, 146) that will be applied to a charge controller (see e.g., 106, 120, 134, 148). The charge controller (see e.g., 106, 120, 134, 148) regulates the voltage and current to charge hybrid capacitor 42 to its maximum rated voltage in a short amount of time with minimal voltage drop due to internal resistance of the hybrid capacitor 42.

As will be generally understood, there are multiple methods of charging including constant voltage, constant current, and a combination of constant current and constant voltage. Constant voltage charging allows for a high current that gradually decreases resulting in fast charging rates, however, this method is not suitable for all energy storage devices (i.e., Lithium-ion batteries). Constant current charging uses a set current level to charge the energy storage device which may cause relatively long charge times. Combination constant current/constant voltage (CC/CV) charging limits the current to a pre-set level until the energy storage device reaches a specific voltage level and then switches to constant voltage (the current is reduced as the energy storage device becomes fully charged). The combination CC/CV charging allows for fast charging that is suitable for a variety of energy storage devices including Lithium-ion batteries and hybrid capacitors.

As shown in FIG. 12A, in a first circuit arrangement 100 a charge path 102 for hybrid capacitor 42 includes a voltage input, shown as a DC voltage input 104 (i.e., hair cutter 10 is connected for charging) and a charge controller, shown as a buck converter CC/CV 106 that allows for combination CC/CV charging and is connected to the hybrid capacitor 42. DC voltage input 104 is applied to buck converter CC/CV 106. As is generally understood, buck converter CC/CV 106 is a switching regulator that takes in an input and steps down the voltage of that input in order to reach a required output with a good power efficiency relative to other converters such as linear regulators. A discharge path 108 for the first circuit arrangement 100 is connected to the hybrid capacitor 42. Discharge path 108 includes a voltage regulator, shown as a boost converter 110 that is connected to and extends between hybrid capacitor 42 and a brushless DC motor 112. The boost converter 110 takes in an input, in this case from hybrid capacitor 42 and steps up the voltage (while stepping down the current) of that input in order to reach the output that will be applied to brushless DC motor 112. The use of the voltage regulator and specifically boost converter 110 allows the brushless DC motor 112 to be driven at a desired voltage.

FIG. 12B, shows a second circuit arrangement 114, according to an exemplary embodiment. A charge path 116 for hybrid capacitor 42 includes a voltage input, shown as a DC voltage input 118 and a charge controller, shown as a buck converter CC/CV 120 that allows for combination CC/CV charging and is connected to the hybrid capacitor 42. A discharge path 122 of the second circuit arrangement 114 includes a voltage regulator, shown as buck-boost converter 124 connected to a brushless DC motor 126. As is generally understood, a buck-boost converter 124 produces an output voltage that is either larger or smaller than the input voltage. In other words, buck-boost converter 124 combines the functions of a boost converter (e.g., 110) and buck converter (e.g., 110) to create a constant output voltage. When the energy source is rechargeable like hybrid capacitor 42, as the hybrid capacitor 42 discharges with use of hair cutter 10, the voltage falls and if directly connected to brushless DC motor 126 the performance of the motor would vary with the voltage of hybrid capacitor 42. Instead, the buck-boost converter 124 maintains a stable voltage to power brushless DC motor 126 such that the performance of hair cutter 10 does not decline with the discharge of hybrid capacitor 42.

FIG. 12C, shows a third circuit arrangement 128, according to an exemplary embodiment. A charge path 130 for hybrid capacitor 42 includes a voltage input, shown as a DC voltage input 132 and a charge controller, shown as a buck converter CC/CV 134 that is connected to the hybrid capacitor 42. A discharge path 136 of the third circuit arrangement 128 includes a buck-boost converter 138 connected to a brushed DC motor 140.

FIG. 12D, shows a fourth circuit arrangement 142, according to an exemplary embodiment. A charge path 144 for hybrid capacitor 42 includes a voltage input, shown as a DC voltage input 146 and a charge controller, shown as a buck converter CC/CV 148 that is connected to the hybrid capacitor 42. The discharge path 150 of the fourth circuit arrangement 142 includes a pulse-width modulator 152 connected to a brushed DC motor 154. As is generally understood, a pulse-width modulator or PWM 152 uses a series of on/off pulses to control the motor. Varying the width of the pulses changes the voltage applied to the brushed DC motor 154 (i.e., longer on pulse causes faster motor rotation, shorter on pulse causes slower motor rotation). Using a pulse-width modulator 152 reduces power dissipation allowing for speed stability of the brushed DC motor 154.

In other words, in various embodiments the power assembly 48 and specifically the discharge path (e.g., 108, 122, 136, 150) includes a regulator (see e.g., 110, 124, 138, 152) between the energy storage device or hybrid capacitor 42 and the motor (see e.g., 112, 126, 140, 154). The regulator (see e.g., 110, 124, 138, 152) is at least one of a buck converter (e.g., 120), a boost converter 110, a buck-boost converter 124, 138, and a pulse-width modulator 152.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions and arrangement of the various exemplary embodiments without departing from the scope of the present invention.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

What is claimed is:

1. A hair cutter comprising:
a handle having an enclosure defining an interior;
a stationary blade fixed to the enclosure, the stationary blade including a first set of cutting teeth;
a translating blade including a second set of cutting teeth and slidably supported relative to the stationary blade such that the first set of cutting teeth and the second set of cutting teeth cooperate to cut hair when the translating blade is slid relative to the stationary blade;
an electric motor supported within the interior of the handle and having first and second contacts, the electric motor being fixed to the enclosure and coupled to the translating blade to slide the translating blade relative to the stationary blade when electrical energy is applied to the electric motor;
a capacitor having a capacitance of at least 150 Farads and a volume less than 1 cubic inch, the capacitor comprising:
a first electrode;
a second electrode, the first and second electrodes separated by an ion-permeable membrane; and
an electrolyte, the electrolyte connecting the first and second electrode; and
a circuit for connecting the first and second contacts of the electric motor to the first and second electrodes of the capacitor to selectively apply electrical energy from the capacitor to the electric motor;
wherein an energy storage capacity of the capacitor is less than 0.3 watt hours.

2. The hair cutter of claim 1, further comprising a second capacitor connected to the capacitor in parallel.

3. The hair cutter of claim 1, wherein the capacitor is a hybrid capacitor supported within the interior.

4. The hair cutter of claim 3, wherein the hybrid capacitor has a capacitance of at least 200 Farads and a volume less than 0.5 cubic inches.

5. The hair cutter of claim 1, wherein the electric motor is a direct current electric motor.

6. The hair cutter of claim 5, wherein the electric motor is a brushless direct current motor.

7. The hair cutter of claim 1, further comprising a yoke attached to the translating blade and the electric motor includes a rotatable shaft having an offset which couples the electric motor to the translating blade via its interaction with the yoke.

8. The hair cutter of claim 1, the circuit further comprising a regulator between the capacitor and the electric motor, wherein the regulator is at least one of a buck converter, a boost converter, a buck-boost converter, and a pulse-width modulator.

9. The hair cutter of claim 1, wherein the hair cutter has a run time of at least 5 minutes.

10. A hair cutter comprising:
a handle having an enclosure defining an interior;
a stationary blade fixed to the enclosure, the stationary blade including a first set of cutting teeth;
a translating blade including a second set of cutting teeth and slidably supported relative to the stationary blade such that the first set of cutting teeth and the second set of cutting teeth cooperate to cut hair when the translating blade slides relative to the stationary blade;
an electric motor supported within the interior of the handle and having first and second contacts, the electric motor being fixed to the enclosure and coupled to the translating blade to slide the translating blade relative to the stationary blade when electrical energy is applied to the electric motor;
an energy storage device supported within the interior of the handle, the energy storage device comprising:
a first capacitor comprising:
a first electrode;
a second electrode, the first and second electrodes separated by an ion-permeable membrane; and
an electrolyte, the electrolyte connecting the first and second electrodes; and
a second capacitor connected to the first capacitor in parallel, the second capacitor comprising:
a third electrode;
a fourth electrode, the third and fourth electrodes separated by an ion-permeable membrane; and
an electrolyte, the electrolyte connecting the third and fourth electrodes; and
a circuit for connecting the first and second contacts to the energy storage device to selectively apply electrical energy from the energy storage device to the electric motor.

11. The hair cutter of claim 10, wherein the energy storage device has a capacitance greater than 200 Farads and a volume less than 1 cubic inch.

12. The hair cutter of claim 10, wherein the energy storage device has a capacitance greater than 400 Farads and a volume less than 1 cubic inch.

13. The hair cutter of claim 10, wherein the first capacitor and second capacitor are hybrid capacitors.

14. The hair cutter of claim 10, wherein the electric motor is a brushed direct current motor.

15. The hair cutter of claim 10, wherein, when the energy storage device is charged for 3 minutes, the hair cutter has a run time of at least 10 minutes.

16. A cordless hair cutter powered by rechargeable electrical energy storage device, the cordless hair cutter comprising:
a handle having an enclosure defining an interior;
a stationary blade fixed to the enclosure, the stationary blade including a first set of cutting teeth;
a translating blade including a second set of cutting teeth and slidably supported relative to the stationary blade such that the first set of cutting teeth and the second set of cutting teeth cooperate to cut hair when the translating blade slides relative to the stationary blade;
an electric motor having first and second contacts, the electric motor being fixed to the enclosure and coupled to the translating blade to slide the translating blade relative to the stationary blade when electrical energy is applied to the electric motor;
an energy storage device supported within the interior; and
a circuit for connecting the first and second contacts to the energy storage device to selectively apply electrical energy from the energy storage device to the electric motor;
wherein the energy storage device has a ratio of charge time to run time of about 1 to 5.

17. The cordless hair cutter of claim 16, the energy storage device further comprising:
a first hybrid capacitor comprising:
a first electrode;
a second electrode, the first and second electrodes separated by an ion-permeable membrane; and
an electrolyte, the electrolyte connecting the first and second electrodes; and
a second hybrid capacitor connected to the first hybrid capacitor in parallel, the second hybrid capacitor comprising:
a third electrode;
a fourth electrode, the third and fourth electrodes separated by an ion-permeable membrane; and
an electrolyte, the electrolyte connecting the third and fourth electrodes.

18. The cordless hair cutter of claim 17, wherein a total energy storage capacity of the energy storage device is less than 0.5 watt hours.

19. The cordless hair cutter of claim 16, the circuit further comprising a regulator between the energy storage device and the electric motor, wherein the regulator is at least one of a buck converter, a boost converter, a buck-boost converter, and a pulse-width modulator.

20. The cordless hair cutter of claim 16, wherein the energy storage device has a capacitance greater than 400 Farads and a volume less than 1 cubic inch.
